(19) United States
(12) Patent Application Publication
(10) Pub. No.: US 2014/0231112 A1
(43) Pub. Date: Aug. 21, 2014

(54) HAND POWER TOOL DEVICE

(71) Applicant: Robert Bosch GmbH, Stuttgart (DE)

(72) Inventors: Manfred Schuele, Sulzbach-Laufen (DE); Helmut Wanek, Kirchheim/Neckar (DE); Cornelius Boeck, Kirchheim (DE); Joachim Schadow, Stuttgart (DE); Joerg Maute, Sindelfingen (DE); Florian Esenwein, Leinfelden-Echterdingen (DE); Manfred Lutz, Filderstadt (DE); Daniel Barth, Leinfelden-Echterdingen (DE)

(73) Assignee: Robert Bosch GmbH, Stuttgart (DE)

(21) Appl. No.: 14/183,603

(22) Filed: Feb. 19, 2014

(30) Foreign Application Priority Data
Feb. 19, 2013 (DE) 10 2013 202 673.0

(51) Int. Cl. B23Q 11/12; B25F 5/00; B23Q 11/00

(52) U.S. Cl. CPC B23Q 11/127; B23Q 11/0046; B25F 5/008
USPC 173/1; 173/198

(57) ABSTRACT

A hand power tool device includes a drive unit, an electronic unit, and a suction unit configured to extract dust out of a working region by suction. The hand power tool device further includes a cooling unit configured, at least partially, to cool the drive unit and/or the electronic unit. The cooling unit and the suction unit are configured, at least partially, as a single piece.

This application claims priority under 35 U.S.C. §119 to patent application no. DE 10 2013 202 673.0 filed on Feb. 19, 2013 in Germany, the disclosure of which is incorporated herein by reference in its entirety.

### BACKGROUND

A hand power tool device has already been proposed.

### SUMMARY

The disclosure is based on a hand power tool device, having a drive unit and an electronic unit, and having a suction unit provided for extracting, in particular, dust out of a working region by suction, and having a cooling unit provided, at least partially, for cooling the drive unit and/or the electronic unit.

It is proposed that the cooling unit and the suction unit be realized, at least partially, as a single piece. A “drive unit” in this context is to be understood to mean, in particular, a unit provided, at least partially, to drive an insert tool coupled to the hand power tool in an operating state. “Provided” is to be understood to mean, in particular, specially designed, configured and/or specially equipped. The drive unit preferably comprises at least one electric motor. It is also conceivable, however, for the drive unit to be realized, at least partially, such that it can be driven pneumatically and/or in another manner considered appropriate by persons skilled in the art. An “electronic unit” in this context is to be understood to mean, in particular, a unit provided, at least partially, to control, in particular, the drive unit of the hand power tool, by open-loop and/or closed-loop control, at least when the hand power tool is in an operating state. Preferably, the electronic unit comprises at least one motor controller of the drive unit. The electronic unit preferably has electronic components such as, in particular, at least one transistor, at least one capacitor, at least one processor, particularly preferably at least one field-effect transistor (MOSFET) and/or at least one bipolar transistor, in particular having an insulated gate electrode (IGBT).

“Extracting by suction” in this context is to be understood to mean, in particular, at least partially, carrying away and/or removal of, at least, the dust, in particular, at least partially, by means of an airstream, particularly preferably by a negative pressure.

“Cooling ” in this context is to be understood to mean, in particular, an at least partial removal of thermal energy that is produced and/or given off, in particular when the hand power tool is in an operating state, in particular from at least one heat-critical component of the hand power tool. A “heat-critical” component in this context is to be understood to mean, in particular, an element, a unit and/or a region of the hand power tool whose operation and/or function may be negatively affected by the thermal energy produced, in particular when the hand power tool is in an operating state, and/or may be destroyed, at least partially, by the thermal energy produced, in particular when the hand power tool is in an operating state. In a particularly preferred exemplary embodiment, in particular, the drive unit and/or the electronic unit comprises/comprise a heat-critical component of the hand power tool. Alternatively or additionally, the cooling device may also be provided, at least partially, for cooling another unit considered appropriate by persons skilled in the art, and/or another element and/or region considered appropriate by persons skilled in the art, such as, in particular, a grip region of the hand power tool.

Two units realized “partially as a single piece” is to be understood to mean, in particular, that the units have at least one common element, in particular at least two, advantageously at least three common elements that are a constituent part, in particular a functionally important constituent part, of both units.

The design according to the disclosure makes it possible to achieve an advantageously compact design of the hand power tool device.

Moreover, it is proposed that the suction unit have at least one connection element, which is provided, at least partially, for coupling the suction unit to an external suction device. The connection element is provided, at least partially, for detachably coupling the suction unit to an external suction device. Preferably good cooling and consequently, in particular, an advantageously high power density of the hand power tool provided with the hand power tool device can thus be achieved.

Furthermore, it is proposed that the external suction device comprise, at least partially, a dust extractor. As a result, the suction by the external suction device can be designed in a preferably simple and inexpensive manner.

It is additionally proposed that the cooling unit be provided, at least partially, for active cooling. “Active cooling” in this context is to be understood to mean, in particular, that a thermal energy is carried away and/or routed away, at least partially, preferably at least almost completely, from a component to be cooled, in particular from a functional unit, in particular by means of a cooling stream. Preferably, by means of the active cooling, it is possible to achieve a removal of heat that, in particular, is at least 30%, preferably at least 50%, and particularly preferably at least 70% greater than in the case of a passive cooling such as, for example, an unforced and/or free convection cooling. As a result, an advantageously effective cooling of the hand power tool device can be achieved.

Moreover, it is proposed that the suction unit be provided, at least partially, for generating a cooling stream. A “cooling stream” in this context is to be understood to mean, in particular, a fluid that, when the cooling unit is in an operating state, flows with a flow velocity of, in particular, at least 0.001 ^{m}/ₛ, preferably at least 0.005 ^{m}/ₛ, preferably at least 0.01 ^{m}/ₛ, and particularly preferably at least 0.02 ^{m}/ₛ, in particular along a flow channel and/or cooling channel. Preferably good cooling and consequently, in particular, an advantageously high power density of the hand power tool device can thus be achieved.

It is additionally proposed that the drive unit comprise at least one EC motor. An “EC motor” in this context is to be understood to mean, in particular, a brushless, electrically commutated direct-current motor. This makes it possible to achieve a preferably high-power, advantageously compact and inexpensive design of the drive unit of the hand power tool.

The hand power tool according to the disclosure is not intended in this case to be limited to the application and embodiment described above. In particular, the hand power tool device according to the disclosure may have individual elements, components and units that differ in number from a number stated herein, in order to fulfill a principle of function described herein.

### BRIEF DESCRIPTION OF THE DRAWINGS

Further advantages are given by the following description of the drawings. The drawings show two exemplary embodiments of the disclosure. The drawings, the description, and the claims contain numerous features in combination. Persons skilled in the art will also expediently consider the features individually and combine them to create appropriate further combinations.

In the drawings:

FIG. 1 shows a perspective view of a hand power tool according to the disclosure,

FIG. 2 shows a schematic sectional view of the hand power tool according to the disclosure, and

FIG. 3 shows a schematic sectional view of an alternative design of the hand power tool according to the disclosure.

### DETAILED DESCRIPTION

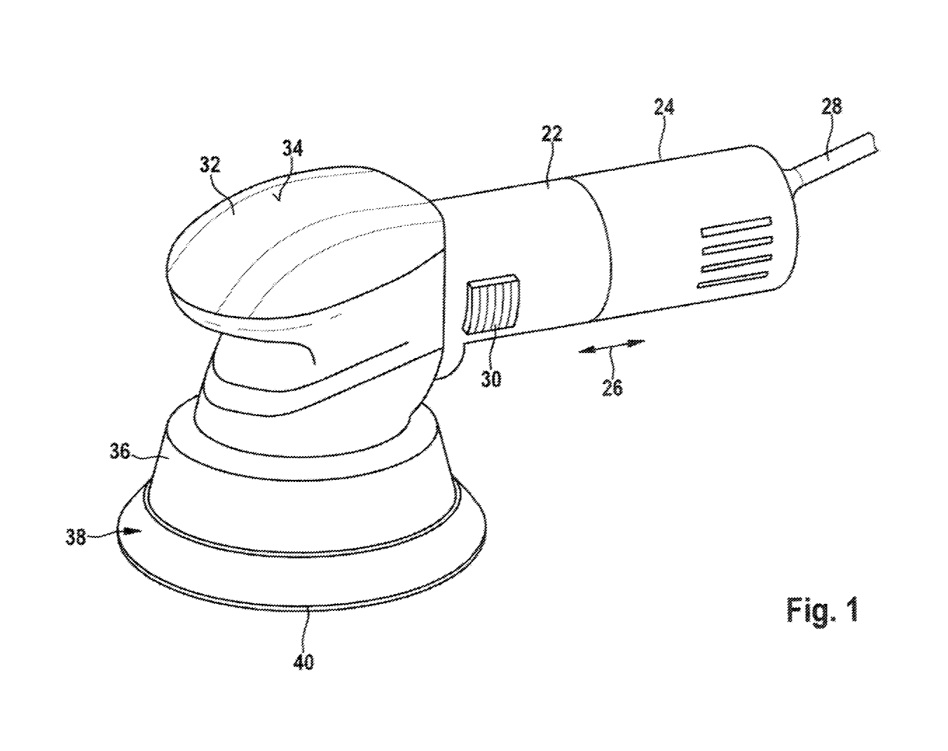

A hand power tool is represented in FIG. 1. The hand power tool is constituted by a random-orbit sander. Also conceivable, however, are other designs of the hand power tool considered appropriate by persons skilled in the art, such as, for example, as a power drill, hammer drill, oscillating hand power tool or angle grinder. The hand power tool comprises a housing 22. The housing 22 is made of a plastic. The housing 22 constitutes a main handle 24, which is provided to be gripped by an operating hand of an operator. A power cable 28 is disposed at one end of the housing 22, as viewed in the direction of main extent 26 of the hand power tool. The power cable 28 is provided to supply electrical energy to a drive unit 10. The power cable 28 is provided to be connected to an electrical power network. For this purpose, the power cable 28 has a plug element, not represented. It is also conceivable, however, for the hand power tool to be constituted by a battery-powered hand power tool. The hand power tool additionally has a switching element 30, which is designed to be operated by an operator. The switching element 30 is provided to activate the drive unit 10. The switching element 30 is constituted by a slide switch.

The housing 22 additionally has an ancillary grip region 32. The ancillary grip region 32 is disposed at an end of the housing 22 opposite to the power cable 28. The ancillary grip region 32 is provided to be gripped by a further operating hand of the operator. In the ancillary grip region 32, the housing 22 has a rubber coating. The ancillary grip region 32 has a convexly curved grip surface 34, on which the rubber coating is applied.

The hand power tool additionally has a transmission housing 36. The transmission housing 36 is connected to the housing 22, at an end of the housing 22 opposite to the power cable 28. The transmission housing 36 is made of a metal. The transmission housing 36 is made of aluminum. The hand power tool comprises a tool receiver 38, not represented in greater detail, which is provided to receive and captively hold an insert tool 40. The tool receiver 38 is constituted by a backing pad. The insert tool 40 is constituted by an abrasive disk. The insert tool 40 is detachably connected to the tool receiver 38. The tool receiver 38 is disposed at an open end of the transmission housing 36, as viewed perpendicularly in relation to the direction of main extent 26 of the hand power tool. The tool receiver 38 projects out of the transmission housing 36.

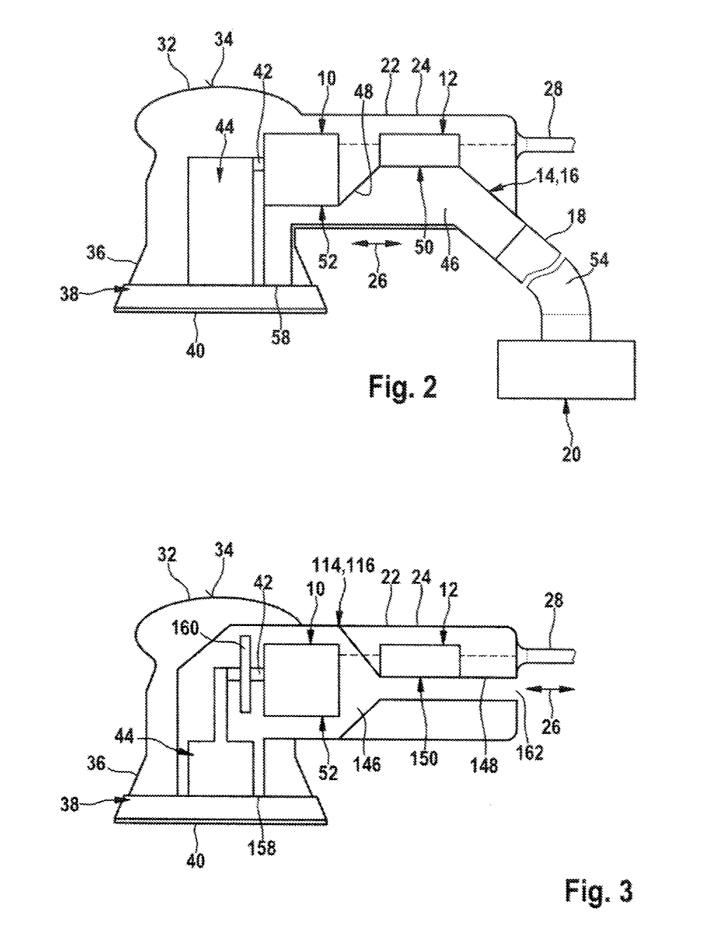

The hand power tool comprises a hand power tool device. The hand power tool device has the drive unit 10, an electronic unit 12, a suction unit 14 and a cooling unit 16 (FIG. 2). The housing 22 of the hand power tool surrounds the drive unit 10, the electronic unit 12 and the cooling unit 16. The drive unit 10 comprises an electric motor. The drive unit 10 comprises an EC motor. The drive unit 10 has an output shaft 42, which is connected to the tool receiver 38, in a manner not represented in greater detail, via a transmission unit 44. The transmission unit 44 has a bevel gear transmission, not represented. The transmission unit 44 is provided for converting an output motion of the output shaft 42 of the drive unit 10 into an eccentric driving motion of the tool receiver 38. The transmission unit 44 is provided for driving the insert tool 40, which is coupled to the tool receiver 38. The transmission unit 44 is connected to the tool receiver 38. The transmission unit 44 is connected to the tool receiver 38 in a form-fitting and/or force-fitting manner.

The drive unit 10 is operatively connected to the electronic unit 12. The drive unit 10 is electronically connected to the electronic unit 12. The electronic unit 12 is provided for open-loop control or closed-loop control of the drive unit 10. Alternatively or additionally, the electronic unit 12 may also be provided for open-loop control or closed-loop control of a further functional unit considered appropriate by persons skilled in the art. The electronic unit 12 comprises field-effect transistors. The electronic unit 12 comprises metal-oxide semiconductor field-effect transistors (MOSFET). Alternatively or additionally, the electronic unit 12 may also comprise other electronic components, considered appropriate by persons skilled in the art, such as, for example, a bipolar transistor having an insulated gate electrode (IGBT).

The cooling unit 16 is provided for cooling the drive unit 10 and the electronic unit 12. It is also conceivable, however, for the cooling unit 16 to be provided for cooling the drive unit 10 or the electronic unit 12. Alternatively or additionally, it is also conceivable for the cooling unit 16 to be provided for cooling a different functional unit considered appropriate by persons skilled in the art. The cooling unit 16 comprises a cooling channel 46, which is provided to guide a cooling stream. The cooling channel 46 extends from the end of the hand power tool that faces toward the power cable 28 to the end of the hand power tool that faces toward the tool receiver 38, as viewed in the direction of main extent 26 of the hand power tool.

The cooling channel 46 is provided to bring the cooling stream into thermal contact with the electronic unit 12 and with the drive unit 10. A wall 48 of the cooling channel 46 contacts the electronic unit 12. The wall 48 of the cooling channel 46 has a high thermal conductivity in a region 50 of contact with the electronic unit 12. The cooling stream in this case absorbs thermal energy given off by the electronic unit 12 when in an operating state, and carries the absorbed thermal energy away from the electronic unit 12. Alternatively, it is also conceivable for the cooling channel 46 to surround the electronic unit 12, at least partially, and for the cooling stream to flow directly past the electronic unit 12.

A wall 48 of the cooling channel 46 contacts the drive unit 10. In a further region 52 of contact with the drive unit 10, the wall 48 of the cooling channel 46 has a high thermal conductivity. The cooling stream in this case absorbs thermal energy given off by the drive unit 10 when in an operating state, and carries the absorbed thermal energy away from the drive unit 10. Alternatively, it is also conceivable for the cooling channel 46 to surround the drive unit 10, at least partially, and for the cooling stream to flow directly past the drive unit 10.

The suction unit 14 comprises a connection element 18, which is provided for coupling the suction unit 14 to an external suction device 20. The external suction device 20 comprises a dust extractor. The connection element 18 is constituted by a connection piece, which is realized for coupling to a suction hose 54 of the external suction device 20. The connection element 18 is disposed at the end of the hand power tool that faces toward the power cable 28. The external suction device 20 is provided to generate a suction airstream when in an operating state. The cooling unit 16 and the suction unit 14 are realized as a single piece. The connection element 18 couples the suction airstream of the external suction device 20 to the cooling channel 46 of the cooling unit 16. The cooling unit 16 is provided for active cooling. The suction airstream constitutes a cooling stream. The external suction device 20 is thus provided for generating the cooling stream.

The external suction device 20, which is coupled to the connection element 18, generates a negative pressure when in an operating state. As a result, ambient air is drawn in, out of a working region of the hand power tool, through an intake opening 58. The resultant suction airstream flows through the cooling channel 46 to the connection element 18. The cooling channel 46 extends from the intake opening 58 to the connection element 18. When in an operating state, the suction airstream, which takes up dust and dirt from the working region and carries them away out of the working region, flows through the cooling channel 46, past the drive unit 10 and the electronic unit 12, and thereby cools these units.

The following descriptions and the drawing are limited substantially to the differences between the exemplary embodiments and, in principle, reference may be made to the drawings and/or the description of the other exemplary embodiments, in particular to FIGS. 1 and 2, in respect of components having the same designation, in particular in respect of components having the same reference numerals. In order to differentiate the exemplary embodiments, the number 1 has been prefixed to the reference numerals of the exemplary embodiment in FIG. 3.

A hand power tool, which is constituted by an angle grinder, is represented in FIG. 3. The hand power tool comprises a hand power tool device. The hand power tool device has a drive unit 10 and an electronic unit 12, and has a cooling unit 116 for cooling the drive unit 10 and the electronic unit 12. The drive unit 10 and the electronic unit 12 correspond to the already described drive unit 10 and the already described electronic unit 12.

The cooling unit 116 is provided for cooling the drive unit 10 and the electronic unit 12. It is also conceivable, however, for the cooling unit 116 to be provided for cooling the drive unit 10 or the electronic unit 12. Alternatively or additionally, it is also conceivable for the cooling unit 116 to be provided for cooling a different functional unit considered appropriate by persons skilled in the art. The cooling unit 116 comprises a cooling channel 146, which is provided to guide a cooling stream. The cooling channel 146 extends from an end of the hand power tool that faces toward the power cable 28 to an end of the hand power tool that faces toward the tool receiver 38, as viewed in the direction of main extent 26 of the hand power tool.

The cooling channel 146 is provided to bring the cooling stream into thermal contact with the electronic unit 12 and with the drive unit 10. A wall 148 of the cooling channel 146 contacts the electronic unit 12. The wall 148 of the cooling channel 146 has a high thermal conductivity in a region 150 of contact with the electronic unit 12. The cooling stream in this case absorbs thermal energy given off by the electronic unit 12 when in an operating state, and carries the absorbed thermal energy away from the electronic unit 12. Alternatively, it is also conceivable for the cooling channel 146 to surround the electronic unit 12, at least partially, and for the cooling stream to flow directly past the electronic unit 12.

The cooling channel 146 surrounds the drive unit 10. When the cooling unit 116 is in an operating state, the cooling stream flows directly past the drive unit 10. The cooling stream in this case absorbs thermal energy given off by the drive unit 10 when in an operating state, and carries the absorbed thermal energy away from the drive unit 10. Alternatively, it is also conceivable for the wall 148 of the cooling channel 146 to contact the drive unit 10, at least partially, and for the wall 148 of the cooling channel 146 to have a high thermal conductivity in a region of contact with the drive unit 10 that is not represented.

The hand power tool has a suction unit 114, which is provided for extracting dust and dirt out of a working region of the hand power tool by suction. The suction unit 114 has a fan element 160. The fan element 160 is constituted by a fan propeller, and is connected to the output shaft 42 of the drive unit 10 in a rotationally fixed manner. The fan element 160, when in an operating state, produces a cooling stream that, in an operating state, goes from an intake opening 158, at an end that faces toward the tool receiver 38, to an outlet opening 162, at an end of the hand power tool that faces toward the power cable 28.

Therefore, when the drive unit 10 is in an operating state, ambient air is drawn in through the intake opening 158, out of the working region of the hand power tool. The resultant suction airstream flows through the cooling channel 146 to the outlet opening 162. The cooling channel 146 extends from the intake opening 158 to the outlet opening 162. When in an operating state, the suction airstream, which takes up dust and dirt from the working region and carries them away out of the working region, flows through the cooling channel 146, past the drive unit 10 and the electronic unit 12, and thereby cools these units. The outlet opening 162 is provided to discharge the suction airstream, or the cooling stream, to an environment of the hand power tool, after cooling the drive unit 10 and the electronic unit 12. The outlet opening 162 is let into the housing 22 of the hand power tool.

What is claimed is:

1. A hand power tool device, comprising:
a drive unit;
an electronic unit;
a suction unit configured to extract dust out of a working region by suction; and
a cooling unit configured, at least partially, to cool one or more of the drive unit and the electronic unit,
wherein the cooling unit and the suction unit are configured, at least partially, as a single piece.

2. The hand power tool device according to claim 1, wherein the suction unit has at least one connection element configured, at least partially, to couple the suction unit to an external suction device.

3. The hand power tool device according to claim 2, wherein the external suction device comprises, at least partially, a dust extractor.

4. The hand power tool device according to claim 1, wherein the cooling unit is configured, at least partially, for active cooling.

5. The hand power tool device according to claim 1, wherein the suction unit is configured, at least partially, to generate a cooling stream.

6. The hand power tool device according to claim 1, wherein the drive unit comprises at least one EC motor.

7. A system, comprising:
at least one hand power tool device including:
a drive unit;
an electronic unit;
a suction unit configured to extract dust out of a working region by suction; and
a cooling unit configured, at least partially, to cool one or more of the drive unit and the electronic unit,
wherein the cooling unit and the suction unit are configured, at least partially, as a single piece; and
at least one external suction device.

8. The system according to claim 7, wherein a hand power tool includes the system.

9. A method for cooling a hand power tool including a hand power tool device, the hand power tool device including a drive unit, an electronic unit, a suction unit configured to extract dust out of a working region by suction, and a cooling unit configured, at least partially, to cool one or more of the drive unit and the electronic unit, the cooling unit and the suction unit being configured, at least partially, as a single piece, the method comprising:
cooling one or more of the drive unit and the electronic unit with the cooling unit.
